(19) United States
(12) Patent Application Publication
(10) Pub. No.: US 2021/0293569 A1
(43) Pub. Date: Sep. 23, 2021

(54) SYSTEM FOR NAVIGATION ROUTE GUIDANCE

(71) Applicants: DENSO International America, Inc., Southfield, MI (US); Denso Corporation, Kariya (JP)

(72) Inventor: Jeffrey TURK, South Lyon, MI (US)

(21) Appl. No.: 16/825,657

(22) Filed: Mar. 20, 2020

(51) Int. Cl. G01C 21/36; G08G 1/0969; G08G 1/0968

(52) U.S. Cl. CPC G01C 21/3667; G08G 1/0969; B60Q 1/346; G01C 21/3697; G08G 1/096861

(57) ABSTRACT

A vehicle computer system includes a display and a processor in communication with the display. The processor is programmed to output a user interface that includes a map portion on the display, wherein the map portion includes map images indicative of at least road geometry and street names, and output on the user interface a route guidance portion including one or more guidance routes indicative of a programmed route to a destination. The processor is also further programmed to output a maneuver portion indicative of an upcoming maneuver associated with the programmed route, wherein the maneuver portion includes a maneuvering street sign image indicative of an upcoming street associated with the upcoming maneuver, wherein the maneuvering street sign image is programmed to flash at a predetermined rate upon approaching the upcoming maneuver.

### TECHNICAL FIELD

The present disclosure relates to navigation systems, including those that provide route guidance.

### BACKGROUND

Vehicles may be equipped with navigation systems. The navigation system may be utilized to provide route information to a destination. The navigation system may activate a route guidance mode when inputting the destination and requesting directions to the destination. The route guidance mode may provide various guidance instructions at various maneuver points to guide the vehicle to the destination.

### SUMMARY

According to one embodiment, a user interface of a display of a vehicle includes a map portion of the display that includes map images indicative of at least road geometry and street names. The user interface also includes a route guidance portion including one or more guidance routes indicative of a programmed route to output on the display, and a maneuver portion indicative of an upcoming maneuver associated with the programmed route, wherein the maneuver portion includes a maneuvering street sign image indicative of an upcoming street associated with the upcoming maneuver, wherein the maneuvering street sign image is programmed to flash at a predetermined rate upon approaching the upcoming maneuver.

According to a second embodiment, a vehicle computer system includes a display and a processor in communication with the display. The processor is programmed to output a user interface that includes a map portion on the display, wherein the map portion includes map images indicative of at least road geometry and street names, and output on the user interface a route guidance portion including one or more guidance routes indicative of a programmed route to a destination. The processor is also further programmed to output a maneuver portion indicative of an upcoming maneuver associated with the programmed route, wherein the maneuver portion includes a maneuvering street sign image indicative of an upcoming street associated with the upcoming maneuver, wherein the maneuvering street sign image is programmed to flash at a predetermined rate upon approaching the upcoming maneuver.

According to a third embodiment, a vehicle computer system includes a display and a processor in communication with the display. The processor may be programmed to output a user interface that includes a map portion on the display, wherein the map portion includes map images indicative of at least road geometry and street names, output on the user interface a route guidance portion including one or more guidance routes indicative of a programmed route to a destination. The processor is also further programmed to output a maneuver portion indicative of an upcoming maneuver associated with the programmed route, wherein the maneuver portion includes a maneuvering graphical image indicative of the upcoming maneuver, wherein the maneuvering graphical image is programmed to flash at a predetermined rate upon approaching the upcoming maneuver.

### BRIEF DESCRIPTION OF THE DRAWINGS

FIG. 1 discloses a vehicle system 1 that includes a navigation apparatus and a data center.

FIG. 2 illustrates an outline of an image display system 200 of the embodiment of the disclosure.

FIG. 3 illustrates an example flow chart 300 according to an embodiment of the disclosure.

FIG. 4A is an exemplary image of a first pulsation of a user interface screen 400.

FIG. 4B is an exemplary embodiment of a user interface screen 450 with a second pulsation rate.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A navigation system may provide route guidance to a driver in order to provide routing instructions. Given that the driver may be occupied with other distractions, route guidance can be difficult for the driver to comprehend in certain scenarios. The distractions may cause a driver to miss maneuvering instructions related to the route guidance. When maneuvering instructions are missed, re-routing can lead to additional frustration, as well as a lengthier commute time. The disclosure below discusses various embodiments that may be utilized to help a driver identify the maneuvering instruction, even during a distracted situation. As discussed below, certain portions of the navigation screen that are used to aid the driver in maneuvering may flash at a predetermined rate to focus the driver's attentions on those aids. Additionally, a turn signal may be activated and flash the portions, similar to those of the navigation screen.

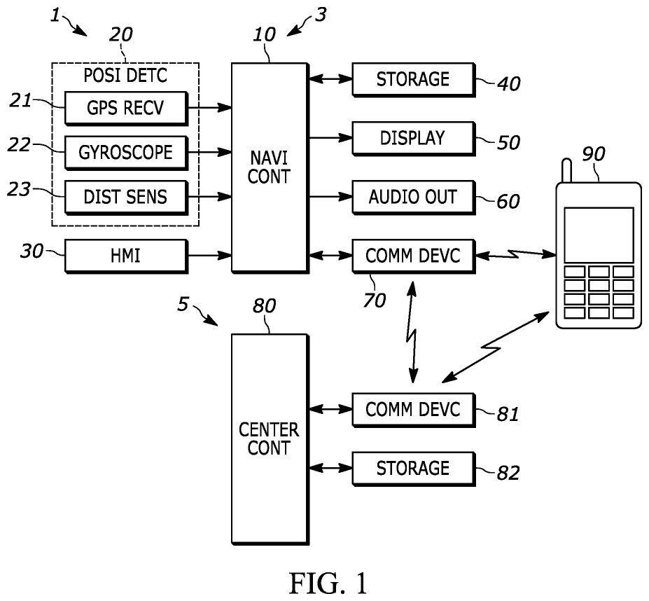

As shown in FIG. 1, a vehicle system 1 includes a navigation apparatus 3 and a data center 5. The navigation apparatus 3 may be equipped in a vehicle and may include a navigation controller (NAVI CONT) 10 or processor. The navigation apparatus may be a portable terminal, such as a smart phone having a navigation function, other than a device equipped to a vehicle. The navigation apparatus may also be an off-board server or system that processes directions and maneuvers off-board that are to be sent to the vehicle. The route may be calculated using a remote service place and pushed into the vehicle storage. The navigation could be played as audio messages or visual indications (e.g. icons). Local position detectors (either on-board or off-board) may be utilized to match car's position to the route info. The navigation controller 10 may include a microcomputer, which has a central processing unit (CPU), a read only memory (ROM), a random-access memory (RAM), an input/output (I/O) interface and a bus line for coupling the CPU, the ROM, the RAM and the I/O interface. The navigation controller 10 may include a position detector (POSI DETC) 20, a user interface or human machine interface (HMI) 30, a storage 40, a display screen (DISPLAY) 50, an audio output device (AUDIO OUT) 60, and a communication device (COMM DEVC) 70. The position detector 20 may detect a present position of the vehicle. The user interface 30 (e.g., HMI 30) may be used for inputting a command from a user to the navigation apparatus 3 or vehicle system 1. The storage 40 may store map data. The display screen 50 may display a map and various information to the user. The audio output device 60 may output audio guidance and sounds to occupants of the vehicle. The communication device 70 of the navigation apparatus 3 may communicate with an off-board server 5. Furthermore, the communication device 70 (or another communication device, such as a wireless transceiver as a Bluetooth transceiver), may be utilized to communication with a mobile device 90, such as a mobile phone. The mobile device 90 may be utilized for handsfree communication or other capabilities based on interoperability with the vehicle system 1.

The position detector 20 may receive signals transmitted from satellites for a global positioning system (GPS). The position detector 20 may include a GPS receiver (GPS RECV) 21, a gyroscope (DIST SENS) 22, and a distance sensor (DIST SENS) 23. The GPS receiver 21 may detect a position coordinate and an altitude of the present position of the vehicle. The gyroscope 22 outputs a detection signal corresponding to an angular velocity of a rotational motion applied to the vehicle. The distance sensor 23 outputs a traveling distance of the vehicle. The navigation controller 10 calculates the present position, a direction, and a velocity of the vehicle based on signals output from the GPS receiver 21, the gyroscope 22, and the distance sensor 23. Further, the present position may be calculated in various methods based on the output signal from the GPS receiver 21. For example, a single point positioning method or a relative positioning method may be used to calculate the present position of the vehicle.

The HMI 30 or user interface 30 includes a touch panel and may include mechanical key switches. The touch panel is integrally set with the display screen 50 on the display screen or located away from the display such as in front of an arm rest. The mechanical key switches are arranged around the display screen 50. When the navigation apparatus 3 provides a remote-control function, operation switches for the remote-control function are arranged in the HMI 30. The HMI 30 may also include a voice recognition system that utilizes voice prompts to operate various vehicle functions. The HMI 30 may also include a haptic device or similar device that allows a user to control and operate the system. The HMI 30 may also include a voice recognition system, remote touchpad, or utilize a stylus pen.

The storage 40, in which the applications and map data is stored, inputs various data included in the map data to the navigation controller 10. The various data includes road data, facility data, point-of-interest (POI) data, address book data, and guidance data. The road data is indicative of a road connection status, and includes node data, which indicates a predetermined position such as an intersection, and link data, which indicates a link that connects adjacent nodes. The facility data is indicative of a facility on the map. The guidance data is used for route guidance. Address book data may be utilized to store custom contacts, locations, and other information (e.g. home or work). POI data may be utilized to identify a POI's location, contact information, category information, review (e.g. Zagat or Yelp) information, etc. Examples of a POI may be a McDonald's under the category of a fast-food restaurant; Starbuck's under coffee shop, a Holiday Inn under the category of hotel, etc. Other POI examples may include, hospitals, dealerships, police stations, cleaners, etc. POIs may be independent business or corporate businesses. The storage 40 may be configured to be rewritable in order to update various applications, software, operating system, and the user interface of the vehicle. For example, a hard disk drive (HDD) and a flash memory may be used as the storage 40.

The display screen 50 may be a color display apparatus having a display surface such as a liquid crystal display. The display screen 50 displays various display windows according to video signal transmitted from the navigation controller 10. Specifically, the display screen 50 displays a map image, a guidance route from a start point to a destination, a mark indicating the present position of the vehicle, and other guidance information. The display screen 50 may also be a touch screen interface that allows for a user to interact with an operating system, software, or other applications via interaction with the screen. The audio output device 60 may output audible prompts and various audio information to the user. With above-described configuration, the route guidance can be performed by displaying viewable information on the display screen 50 and outputting audible information with the audio output device 60.

The display screen 50 may output a navigation interface. The navigation interface may be utilized to display a map includes road geometry, street names, lane guidance information, POI information. During route guidance (e.g., when a user enters a destination in the navigation system to route to), the system may highlight or outline the route on the map by highlighting the route and path that the user should take. The navigation system may output maneuvers when an upcoming maneuver is approaching, such as a turn (e.g., left or right turn, U-turn, etc.), merger, lane change, etc. The navigation system may also include a map portion of the display that includes map images that display road geometry and street names. During route guidance, the map portion may also include the guidance. The map portion may be displayed in a variety of views, including an aerial view, three-dimensional view, north-up view, heads-up view, etc.

During route guidance, the map system may also include a maneuver portion indicative of an upcoming maneuver associated with the route to the destination (e.g., the programmed route). The maneuver portion may include a maneuvering street sign image indicative of an upcoming street associated with the upcoming maneuver, wherein the maneuvering street sign image is programmed to flash at a predetermined rate upon approaching the upcoming maneuver. As explained in more detail below, the navigation system may flash certain portions of the screen during route guidance at certain distances to the maneuvering point.

The communication device 70 may communicate data with the “cloud,” for example, a data center 5. Specifically, the navigation apparatus 3 may be wirelessly coupled to a network via the communication device 70 so that the navigation apparatus 3 performs the data communication with the data center 5. The communication device 70 may be an embedded telematics module or may be a Bluetooth transceiver paired with mobile device 90 utilized to connect to remote servers or the “cloud.” The communication device 70 may be both a Bluetooth communication or another form of wireless (or wired) communication.

The server 5, which is remote from the vehicle, mainly includes a data center controller (CENTER CONT) 80. Similar to the navigation controller 10, the data center controller 80 mainly includes a well-known microcomputer, which has a CPU, a ROM, a RAM, an input/output interface and a bus line for coupling the CPU, the ROM, the RAM and the I/O interface. The data center controller 80 includes a communication device (COMM DEVC) 81, a first storage (FIR STORAGE) 82. The communication device 81 of the data center 5 performs the data communication with the navigation apparatus 3. Specifically, the data center 5 may be wirelessly coupled to the network via the communication device 81 so that the data center 5 performs the data communication with the navigation apparatus 3. The server 5 may be utilized to provide route guidance instructions or other information to the navigation apparatus 3 via the communication device 81.

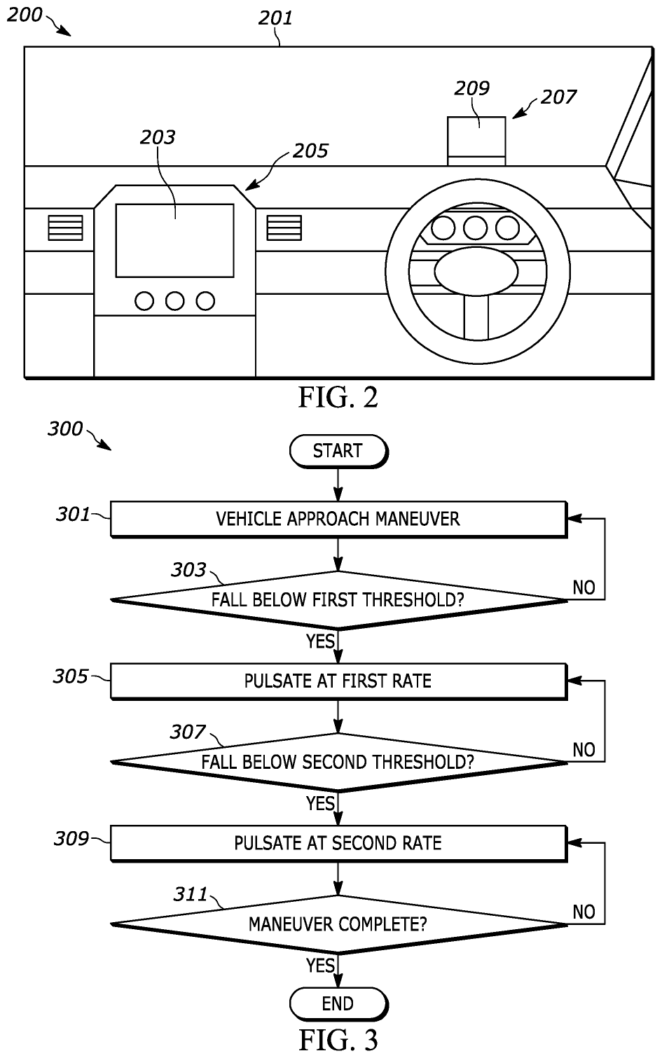

FIG. 2 display an outline of an image display system 200 of the embodiment of the disclosure. The image display system 200 displays images generated by a multimedia system or navigation apparatus 205 that is equipped in the vehicle 201. The image display system may display the images on a head-up display 209 included in a display apparatus 207, or a display 203 of the navigation apparatus 205. Of course, the images may be displayed on any display in the vehicle 201, including a mobile device, instrument cluster, rear seat entertainment display, etc.

The display apparatus 207 may be equipped with the head-up display 209 that is disposed in the vicinity of the front of the driver seat in the vehicle 201. The display apparatus 207 may display the map or route guidance information obtained from the navigation apparatus 205 on the head-up display 209. Since the display apparatus 207 may be disposed in the vicinity of the front of a user, the display apparatus 207 may require less movement of user's visual line compared to the situation where the user looks at a display 203 included in the navigation apparatus 205 that is disposed in the center console or similar area of the vehicle cabin.

However, since the head-up display 209 is disposed in the vicinity of the front of the driver seat, the display size of the head-up display 209 must be small to not to hinder the front visual field of the user. Thus, it may be difficult to display the whole image on the head-up display 209, as opposed to the display 203 of the navigation apparatus 205. Further, since the head-up display 209 may be a transparent glass optical element, the head-up display 209 may provide a different image than that of the display 203. The display 203 may be a liquid crystal display (or similar type of display) in the navigation apparatus 205.

In one embodiment of the image display system 100, an image displayed on the display 203 of the navigation apparatus 205 may be obtained, and a part of the image may be extracted based on layout information relevant to the layout of the image. Then, by use of the extracted part of the image, an image to be displayed on the head-up display 209. The navigation image may be displayed on the head-up display 209. The navigation image may be generated from the image originally for the navigation apparatus 205 that may be one of various models, or it can be recreated.

FIG. 3 displays an example flow chart 300 according to an embodiment of the disclosure. The flow chart 300 may be in route guidance mode in one embodiment. However, other embodiments may not require a route guidance mode, such as navigation systems with predictive destination entry (e.g., based on historic data) for the pulsation to activate on the various portions of the navigation screen. At step 301, the vehicle may be approaching a maneuver that requires the map display to output a maneuver portion that is indicative of an upcoming maneuver associated the route to the destination (e.g., the programmed route). The maneuver portion may be displayed in response to the vehicle passing a first threshold distance. The first threshold distance may be any distance, such as 300 feet. The maneuver portion may include a maneuvering street sign image indicative of an upcoming street associated with the upcoming maneuver, in one embodiment. The maneuver portion may also include lane guidance information in another embodiment.

At step 303, the system may exceed a first threshold distance that is associated with the flashing that may be associated with the maneuvering street sign image. As explained further below, another embodiment may include a second threshold distance that may be less than the first threshold distance. However, in yet another embodiment, only one threshold distance may be utilized to activate a pulsation of various portions of the navigation screen. The threshold distance may trigger activation of various portions of the navigation screen to pulsate when the distance between the vehicle and maneuvering point falls below the threshold (e.g., the vehicle is closer to approaching the maneuvering point), as explained below. For example, if the threshold distance is 100 feet, the system may begin to send instructions to pulsate various portions of the navigation screen when the vehicle is 99 feet away from the maneuvering point. However, if the vehicle does not fall below the threshold distance (e.g., above 100 feet), the system may continue to monitor the distance at which the vehicle is approaching a maneuver during route guidance mode.

At step 305, the system may cause a pulsation of certain areas of the navigation screen at a first rate. The pulsation may be associated with the maneuvering image and street sign image. The maneuvering image and street sign image may be programmed to flash at a predetermined rate (e.g., the first rate) upon approaching the upcoming maneuver. The maneuvering image may be associated with a turn arrow that is associated with the upcoming maneuver during route guidance. In another embodiment, the street image (e.g., street geometry) may also flash at a predetermine rate upon approaching the maneuver. The flashing may be a portion of the route guidance that is overlaid on the street associated with the maneuver. In yet another embodiment, both the street image and the maneuvering action may pulsate in coordination, or in an out-of-sync fashion.

At step 307, the system may fall below a second threshold distance between the vehicle to the maneuver point. The second threshold distance may be associated with causing the maneuvering street sign image to flash or pulsate. The second threshold distance may cause activation of various portions of the navigation screen to pulsate when the distance between the vehicle and maneuvering point falls below the second threshold. The second threshold distance may be less than the first threshold distance. Thus, the system may speed up the pulsation of the maneuvering action and/or street sign image. For example, if the second threshold distance is 25 feet, the system may send instructions for various portions of the navigation screen to pulsate when the vehicle is 24 feet away from the maneuvering point. However, if the vehicle does not fall below the second threshold distance (e.g., above 25 feet), the system may continue to monitor the distance at which the vehicle is approaching a maneuver during route guidance mode. The predetermine rate at which the various portions flash may increase after the vehicle falls below the second threshold distance until the maneuver (e.g., the vehicle is closer to the maneuver point). While the system discloses two different thresholds to change the pulsation rate, any number of thresholds may be utilized that causes changes to the pulsation rate. Furthermore, the pulsation rate may also coordinate directly with the distance to the maneuvering point upon passing a first threshold (or any other threshold).

In another embodiment, the pulsation may occur when a user activates a turn signal during route guidance. Thus, the turn signal may eliminate the need for either a first or second threshold in one embodiment or may be utilized in addition to the thresholds. For example, the driver or occupant may activate a turn signal to output a left turn or right turn to the associated lights of the vehicle. The interface may allow the pulsation to have the same rate as the rate of the turn signal lights. Furthermore, the pulsation may be coordinated with the turn signal light to “flicker” at the same time or same rate as the portions of the navigation screen.

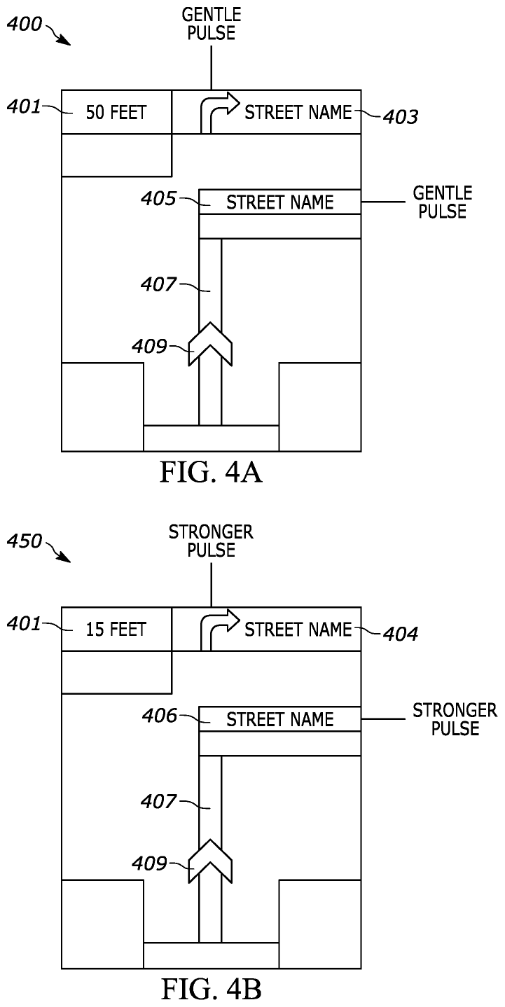

FIG. 4A is an exemplary image of a first pulsation of a user interface screen 400. The interface screen 400 may be any type of interface screen, such as a multimedia display, navigation display, heads-up display, etc. The first pulsation may be a slower pulsation that appears after passing a first threshold. The user interface screen 400 may include a distance-to-maneuver portion 401 located on the user interface. The distance-to-maneuver portion 401 may be located anywhere on the screen, however, distance-to-maneuver portion 401 is located on the upper left portion of the screen in the embodiment described. The distance-to-maneuver portion 401 may indicate the distance between the vehicle and the maneuvering point (e.g., where a vehicle must turn to follow route guidance). The distance-to-maneuver portion 401 may be useful in aiding to determining a pulsation rate of the various images on the interface screen 400.

The interface screen 400 may also include a maneuvering image portion 403. The maneuvering image portion 403 may indicate a graphical image associated with the upcoming maneuver that is required to keep the vehicle on route guidance. As shown in FIG. 4A, the maneuvering image portion 403 may have a gentle pulse (e.g., flash on and off) upon approaching the maneuver. The gentle pulse may be non-obtrusive and can be activated upon the vehicle falling within a threshold distance to the maneuvering point. The pulse brightness may vary by time of day. For example, the pulsation rate may be a certain rate during a night mode (e.g., nighttime driving), and the pulsation rate may be another rate during day mode (e.g., daytime driving). The pulse may also be paired with a turn signal of the vehicle, and thus pulsate at the same rate as the turn signal. Such an embodiment may require that the user activates the turn signal and the vehicle is under route guidance. The maneuvering image portion 403 may include an arrow or other graphical symbol associated with the maneuver, as well as display text that identifies the street name associated with the maneuver. Thus, if the maneuver requires a right turn on Denso Drive, the maneuvering image portion 403 may include a right arrow graphical image, as well as text displaying “DENSO DRIVE” or “DENSO DR.” The maneuvering image portion 403 may pulsate the turn arrow or other graphical image. The maneuvering image portion 403 may also display street signs and utilize graphical images rather than simple text to display the road name to maneuver at.

The interface screen 400 may also include a maneuvering street sign image portion 405. The maneuvering street sign image portion 405 may indicate a graphical image associated with the street (e.g., or road geometry) for upcoming maneuver that is required to keep the vehicle on route guidance. As shown in FIG. 4A, the maneuvering street sign image portion 405 may have a gentle pulse (e.g., flash on and off) upon approaching the maneuver. The gentle pulse may be non-obtrusive and can be activated upon the vehicle falling within a threshold distance to the maneuvering point. The pulse brightness may also vary by time of day. For example, the pulsation rate may be a certain rate during a night mode (e.g., nighttime driving), and the pulsation rate may be another rate during day mode (e.g., daytime driving). The pulse may also be paired with a turn signal of the vehicle, and thus pulsate at the same rate as the turn signal. Such an embodiment may require that the user activates the turn signal and the vehicle is under route guidance. The maneuvering street sign image portion 405 may include images associated with a street sign, freeway entrance/exit, or other graphical symbol associated with the maneuver, as well as display text that identifies the street name associated with the maneuver. Thus, if the maneuver requires a right turn on Denso Drive, the maneuvering street sign image portion 405 may include graphical images indicative of the street sign for Denso Drive, well as text displaying “DENSO DRIVE” or “DENSO DR.”. The maneuvering street sign image portion 405 may pulsate as a whole, only pulsate the text, or pulsate the graphical image, etc.

The interface screen 400 may also include a route guidance portion 407 that may be highlighted. The route guidance highlighted portion 407 may be overlaid onto the road geometry to display to a driver the route information to the destination. Thus, the route guidance highlighted portion 407 may be highlighted if the user is going to maneuver on a portion of the map, as opposed to an unhighlighted portion of the map (e.g., road geometry) that is not affiliated with the route. In another embodiment, the pulsation may also occur at the route guidance highlighted portion 407. The interface screen may also include a graphical image associated with a current vehicle position (“CVP”), sometimes called a CVP icon 409. The CVP icon 409 may display the vehicle's location relevant to the map data. The CVP icon 409 may be an arrow or any other graphical image utilized to represent the vehicle.

FIG. 4B is an exemplary embodiment of a user interface screen 450 with a second pulsation rate. The second pulsation rate may pulse faster than the first pulsation. The second pulsation may be a faster pulsation that appears after passing a second threshold. The user interface screen 450 may include a distance-to-maneuver portion 401 located on the user interface. The distance-to-maneuver portion 401 may be located anywhere on the screen, however, distance-to-maneuver portion 401 is located on the upper left portion of the screen in the embodiment described. The distance-to-maneuver portion 401 may indicate the distance between the vehicle and the maneuvering point (e.g., where a vehicle must turn to follow route guidance). The distance-to-maneuver portion 401 may be useful in aiding to determining a pulsation rate of the various images on the interface screen 450.

The interface screen 450 may also include a maneuvering image portion 404. The maneuvering image portion 404 may indicate a graphical image associated with the upcoming maneuver that is required to keep the vehicle on route guidance. As shown in FIG. 4B, the maneuvering image portion 404 may have a stronger pulse (e.g., flash on and off faster than that of FIG. 4A) upon approaching the maneuver. The stronger pulse may be non-obtrusive and can be activated upon the vehicle falling within a second threshold distance to the maneuvering point. The second threshold distance may be less than the first threshold distance, in one embodiment. The pulse brightness may also vary by time of day. For example, the pulsation rate may be a certain rate during a night mode (e.g., nighttime driving), and the pulsation rate may be another rate during day mode (e.g., daytime driving). The pulse may also be paired with a turn signal of the vehicle, and thus pulsate at the same rate as the turn signal. Such an embodiment may require that the user activates the turn signal and the vehicle is under route guidance. The maneuvering image portion 404 may include an arrow or other graphical symbol associated with the maneuver, as well as display text that identifies the street name associated with the maneuver. Thus, if the maneuver requires a right turn on Denso Drive, the maneuvering image portion 404 may include a right arrow graphical image, as well as text displaying “DENSO DRIVE” or “DENSO DR.” The maneuvering image portion 404 may pulsate the turn arrow or other graphical image. The maneuvering image portion 443 may also display street signs and utilize graphical images rather than simple text to display the road name to maneuver at.

The interface screen 450 may also include a maneuvering street sign image portion 406. The maneuvering street sign image portion 406 may indicate a graphical image associated with the street (e.g., or road geometry) for upcoming maneuver that is required to keep the vehicle on route guidance. As shown in FIG. 4B, the maneuvering street sign image portion 406 may have a stronger pulse (e.g., flash on and off faster than pulsation of the first threshold) upon approaching the maneuver. The gentle pulse may be non-obtrusive and can be activated upon the vehicle falling within a second threshold distance to the maneuvering point. The pulse brightness may also vary by time of day. For example, the pulsation rate may be a certain rate during a night mode (e.g., nighttime driving), and the pulsation rate may be another rate during day mode (e.g., daytime driving). The pulse may also be paired with a turn signal of the vehicle, and thus pulsate at the same rate as the turn signal. Such an embodiment may require that the user activates the turn signal and the vehicle is under route guidance. The maneuvering street sign image portion 406 may include images associated with a street sign, freeway entrance/exit, or other graphical symbol associated with the maneuver, as well as display text that identifies the street name associated with the maneuver. Thus, if the maneuver requires a right turn on Denso Drive, the maneuvering street sign image portion 406 may include graphical images indicative of the street sign for Denso Drive, well as text displaying “DENSO DRIVE” or “DENSO DR.”. The maneuvering street sign image portion 406 may pulsate as a whole, only pulsate the text, or pulsate the whole graphical image, etc.

The interface screen 450 may also include a route guidance highlighted portion 407. The route guidance highlighted portion 407 may be overlaid onto the road geometry to display to a driver the route information to the destination. Thus, the route guidance highlighted portion 407 may be highlighted if the user is going to maneuver on a portion of the map, as opposed to an unhighlighted portion of the map (e.g., road geometry) that is not affiliated with the route. In another embodiment, the pulsation may also occur at the route guidance highlighted portion 407. The interface screen may also include a graphical image associated with a current vehicle position (“CVP”), sometimes called a CVP icon 409. The CVP icon 409 may display the vehicle's location relevant to the map data. The CVP icon 409 may be an arrow or any other graphical image utilized to represent the vehicle.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A user interface of a display of a vehicle, comprising:
a map portion of the display that includes map images indicative of at least road geometry and street names; and
a route guidance portion including one or more guidance routes indicative of a programmed route to output on the display; and
a maneuver portion indicative of an upcoming maneuver associated with the programmed route, wherein the maneuver portion includes a maneuvering street sign image indicative of an upcoming street associated with the upcoming maneuver, wherein the maneuvering street sign image is programmed to flash at a predetermined rate upon approaching the upcoming maneuver.

2. The user interface of claim 1, wherein the predetermined rate is associated with a distance to the upcoming maneuver.

3. The user interface of claim 2, wherein the predetermined rate increases when the vehicle is closer to the upcoming maneuver.

4. The user interface of claim 2, wherein the predetermined rate decreases when the vehicle is further from the upcoming maneuver.

5. The user interface of claim 1, wherein the maneuvering street sign image is programmed to flash in response to activation of a turn signal at the vehicle.

6. The user interface of claim 5, where in the turn signal is programmed to flicker at the predetermined rate associated with the maneuvering street sign image.

7. The user interface of claim 5, wherein the activation of the turn signal is automatic without human intervention.

8. The user interface of claim 1, wherein the maneuver portion is programmed to display the upcoming maneuver in response to a location of the vehicle falling below a first threshold distance between the location of the vehicle and the upcoming maneuver.

9. The user interface of claim 8, wherein the predetermined rate is programmed to flash faster in response to the location of the vehicle falling below a second threshold distance between the location of the vehicle and the upcoming maneuver, wherein the second threshold distance is less than the first threshold distance.

10. A vehicle computer system, comprising:
a display; and
a processor in communication with the display and programmed to, output a user interface that includes a map portion on the display, wherein the map portion includes map images indicative of at least road geometry and street names;
output on the user interface a route guidance portion including one or more guidance routes indicative of a programmed route to a destination; and
a maneuver portion indicative of an upcoming maneuver associated with the programmed route, wherein the maneuver portion includes a maneuvering street sign image indicative of an upcoming street associated with the upcoming maneuver, wherein the maneuvering street sign image is programmed to flash at a predetermined rate upon approaching the upcoming maneuver.

11. The vehicle computer system of claim 10, wherein the maneuver portion includes a maneuvering graphical image indicative of the upcoming maneuver.

12. The vehicle computer system of claim 11, wherein the maneuvering graphical image is programmed to flash at the predetermined rate upon approaching the upcoming maneuver.

13. The vehicle computer system of claim 11, wherein the maneuvering graphical image is programmed to flash at a different predetermined rate upon approaching the upcoming maneuver.

14. The vehicle computer system of claim 10, wherein the predetermined rate is associated with a distance to the upcoming maneuver.

15. The vehicle computer system of claim 14, wherein the predetermined rate increases when the vehicle is closer to the upcoming maneuver.

16. A vehicle computer system, comprising:
a display; and
a processor in communication with the display and programmed to, output a user interface that includes a map portion on the display, wherein the map portion includes map images indicative of at least road geometry and street names;
output on the user interface a route guidance portion including one or more guidance routes indicative of a programmed route to a destination; and
a maneuver portion indicative of an upcoming maneuver associated with the programmed route, wherein the maneuver portion includes a maneuvering graphical image indicative of the upcoming maneuver, wherein the maneuvering graphical image is programmed to flash at a predetermined rate upon approaching the upcoming maneuver.

17. The vehicle computer system of claim 16, wherein the predetermined rate is associated with a distance to the upcoming maneuver.

18. The vehicle computer system of claim 16, wherein the maneuvering graphical image includes a turn arrow associated with the upcoming maneuver.

19. The vehicle computer system of claim 18, wherein the turn arrow is also associated with a turn signal indicator.

20. The vehicle computer system of claim 16, wherein the maneuvering graphical image includes lane guidance information.
